(19) United States
(12) Patent Application Publication
(10) Pub. No.: US 2024/0370859 A1
(43) Pub. Date: Nov. 7, 2024

(54) INTEGRATED CERTIFICATE ISSUING MACHINE FOR FINANCIAL INSTITUTION AND OPERATING METHOD THEREOF

(71) Applicant: Hyosung TNS Inc., Seoul (KR)

(72) Inventors: Sun Woo KIM, Hongcheon-gun (KR); Jin Woo SONG, Seoul (KR)

(21) Appl. No.: 18/631,061

(22) Filed: Apr. 10, 2024

(30) Foreign Application Priority Data
May 4, 2023 (KR) 10-2023-0058693

(51) Int. Cl. G06Q 20/38

(52) U.S. Cl. CPC G06Q 20/38215

(57) ABSTRACT

An integrated certificate issuing machine for a financial institution and an operating method thereof, which support that the issue and management of various types of major certificates that are used in a financial institution can be effectively processed by integrating the issue and management through one integrated certificate issuing machine in a way that the integrated certificate issuing machine is connected to multiple staff terminals for the processing of financial services in the financial institution over an internal communication network and configured to assign an issue number to a certificate assigned to a certificate issue request in response to the certificate issue request from the staff terminal, issue a major certificate containing certificate-containing information based on the certificate-containing information received from the staff terminal, and issue the major certificate through the staff of the staff terminal in issuing and managing the major certificates in the financial institution.

### CROSS-REFERENCE TO RELATED APPLICATIONS

This application claims priority to Republic of Korea Patent Application No. 10-2023-0058693, filed on May 4, 2023, which is incorporated by reference herein in its entirety.

### TECHNICAL FIELD

The present disclosure relates to an integrated certificate issuing machine for a financial institution and an operating method thereof, and more particularly, to an integrated certificate issuing machine for a financial institution and an operating method of the integrated certificate issuing machine, which support that the issue and management of various types of major certificates, such as a bank account, a card, and a check that are used in a financial institution, such as a bank, can be effectively processed by integrating the issue and management through one integrated certificate issuing machine in a way that the integrated certificate issuing machine is connected to multiple staff terminals for the processing of financial services in the financial institution over an internal communication network and configured to assign an issue number to a certificate assigned to a certificate issue request in response to the certificate issue request that is received through the staff terminal, issue a major certificate that contains certificate-containing information based on the certificate-containing information received from the staff terminal, and issue the major certificate through the staff of the staff terminal in issuing and managing the major certificates, such as a bank account, a card, and a check, in the financial institution, such as a bank.

### BACKGROUND ART

In general, major certificates that are used in a financial institution, such as a bank, for business purposes include certificates, such as a bank account, a card, and a check. It is very important to thoroughly manage the quantity of the major certificates according to the type of each certificate due to a security problem.

To this end, conventionally, a staff withdraws a certificate, such as a bank account to be used on a corresponding business day, from a branch safe, registers a corresponding withdrawal history in a computer, and uses the certificate, before the start of each business day, and performs closing business in which the staff settles certificates left after being used on the day by returning the certificates after the business is closed.

In this case, the staff who has initiated the business separately stores, in his or her counter, a not-issued certificate that was previously withdrawn from the safe before the business, and directly issues a corresponding certificate by inputting various types of data for issuing the certificate when there is a request for the issuing of the certificate from a customer. For example, in issuing a bank account, a staff issues a certificate to a customer by inputting data that are necessary to issue the bank account, such as a customer name and an account number, through a bank account issuing machine provided on one side of his or her counter as disclosed in Korean Patent Application Publication No. 10-2007-0038306.

In a certificate issue process according to a conventional technology, however, when the quantity of certificates that have been previously stored in a counter during business is insufficient, a staff has to inconveniently withdraw a certain quantity of certificates from a safe and to register the certificates in a computer one by one. As described above, the process of settling certificates left after being used on the day by returning the certificates again even after business is closed is required. In this case, there is a problem in that business efficiency of a staff is low because the staff has to perform a manual task for checking the quantity of certificates issued for each certificate and the quantity of certificates left in a branch safe one by one in order to manage the inventory of the certificates.

In addition, as described in Korean Patent Application Publication No. 10-2022-0085604, there are recently made various attempts in which a staff withdraws a certain quantity of certificates from a certificate cashier by using his or her terminal, separately stores the withdrawn certificate in an individual digital desk connected to a staff terminal, and issues a certificate in response to a certificate issue request from a customer. In such a method, the comprehensive management of the inventory of major certificates is not easy because the issue and management of the major certificate are also individually performed for each staff. Furthermore, such a method has a limit in being vulnerable to security against a loss/theft due to a limitation in checking the issue history of major certificates in real time.

### SUMMARY

Various embodiments are directed to providing an integrated certificate issuing machine for a financial institution and an operating method of the integrated certificate issuing machine, which support that the issue and management of various types of major certificates, such as a bank account, a card, and a check that are used in a financial institution, such as a bank, can be effectively processed by integrating the issue and management through one integrated certificate issuing machine in a way that the integrated certificate issuing machine is connected to multiple staff terminals for the processing of financial services in the financial institution over an internal communication network and configured to assign an issue number to a certificate assigned to a certificate issue request in response to the certificate issue request that is received through the staff terminal, issue a major certificate that contains certificate-containing information based on the certificate-containing information received from the staff terminal, and issue the major certificate through the staff of the staff terminal in issuing and managing the major certificates, such as a bank account, a card, and a check, in the financial institution, such as a bank.

In an embodiment, in an integrated certificate issuing machine for a financial institution, which is connected to multiple staff terminals and a financial server over an internal communication network of a financial institution and configured to issue and provide a requested certificate in response to a certificate issue request through the staff terminal, the certificate issuing machine is configured to generate an issue number for the requested certificate assigned to each certificate issue request in response to the certificate issue request that is received from each of the multiple staff terminals, receive certificate-containing information to be contained in the requested certificate from the staff terminal, and issue a certificate on which the received certificate-containing information has been printed. Major financial certificates that are requested through the multiple staff terminals are integrated, issued, and managed through the one integrated certificate issuing machine.

The integrated certificate issuing machine for a financial institution and the operating method thereof according to embodiments of the present disclosure can increase business efficiency of a staff because the issue and management of various types of major certificates, such as a bank account, a card, and a check that are used in a financial institution can be effectively processed by integrating the issue and management through one integrated certificate issuing machine in a way that the integrated certificate issuing machine is connected to multiple staff terminals for the processing of financial services in the financial institution over an internal communication network and configured to assign an issue number to a certificate assigned to a certificate issue request in response to the certificate issue request that is received through the staff terminal, issue a major certificate that contains certificate-containing information based on the certificate-containing information received from the staff terminal, and issue the major certificate through the staff of the staff terminal in issuing and managing the major certificates, such as a bank account, a card, and a check, in the financial institution, such as a bank, and can also prevent a loss/theft of major certificates by checking an issue history of major certificates and the quantity of major certificates remained in real time.

### BRIEF DESCRIPTION OF THE DRAWINGS

FIG. 1 is a diagram schematically illustrating an environment in which an integrated certificate issuing machine for a financial institution according to an embodiment of the present disclosure is operated.

FIG. 2 is a block diagram for describing a schematic construction of the integrated certificate issuing machine for a financial institution according to an embodiment of the present disclosure.

FIG. 3 is a flowchart for describing a process of issuing a major certificate through the integrated certificate issuing machine for a financial institution according to an embodiment of the present disclosure.

### DETAILED DESCRIPTION

The present disclosure may be modified in various ways and may have various embodiments. Hereinafter, specific embodiments of the present disclosure are described in detail with reference to the drawings, but the present disclosure is not limited to the following embodiments unless the present disclosure deviates from the subject matter thereof.

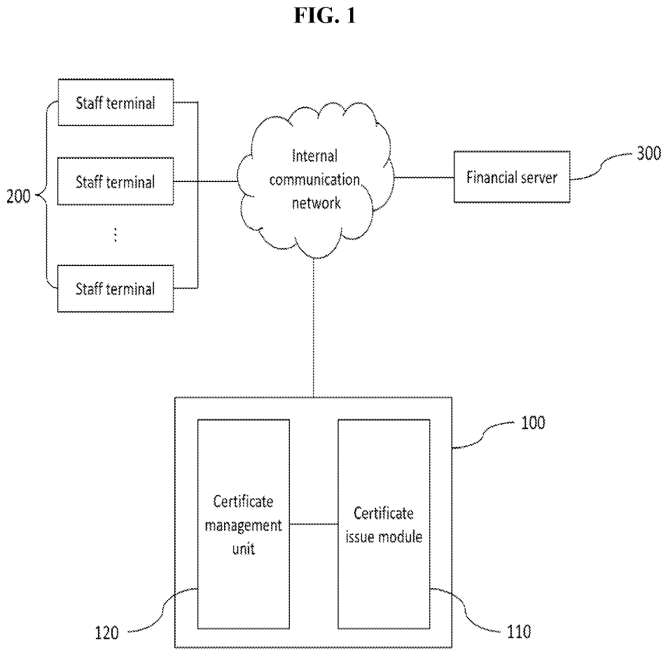

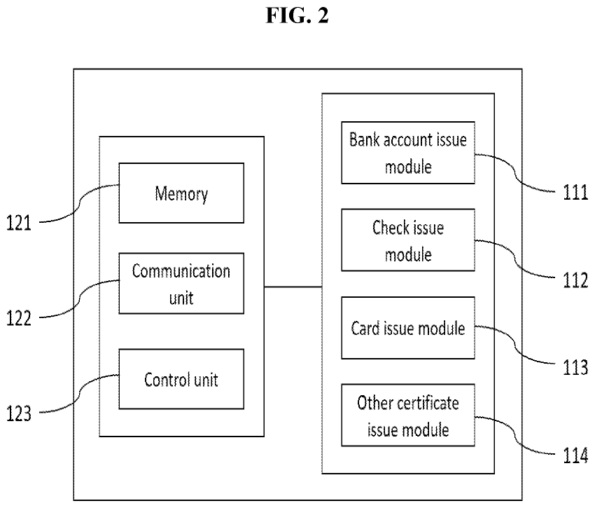

FIG. 1 is a diagram schematically illustrating an environment in which an integrated certificate issuing machine for a financial institution according to an embodiment of the present disclosure is operated. FIG. 2 is a block diagram for describing a schematic construction of the integrated certificate issuing machine for a financial institution according to an embodiment of the present disclosure.

As illustrated in FIG. 1, an integrated certificate issuing machine 100 for a financial institution according to an embodiment of the present disclosure is connected to multiple staff terminals 200 for the processing of financial services in a financial institution, such as a bank, over an internal communication network of the financial institution, and is configured to issue major certificates that contain certificate-containing information based on the certificate-containing information that is received from the staff terminal 200 in response to a certificate issue request that is received from a customer through the staff terminal 200.

In this case, in general, the major certificates that are used in the financial institution may include various types of certificates, such as a bank account, a check, a card, and other certificates such as transaction statement confirmation.

In this case, the certificate issuing machine 100 is disposed in a financial institution, such as a bank in which major certificates are handled, and supports that the issue and current inventory condition of various types of certificates are comprehensively managed.

To this end, the certificate issuing machine 100 is configured to include a certificate issue module 110 configured to issue a certificate by printing various types of information that is necessary to issue the certificate for each not-issued major certificate that has been loaded on to a main body and a certificate management unit 120 configured to control an operation of the certificate issue module 110 and to comprehensively manage a certificate issue history and the quantity of major certificates remained. A detailed construction of the certificate issuing machine 100 will be described more specifically with reference to FIG. 2.

In this case, the certificate issuing machine 100 and the multiple staff terminals 200 are also connected to a financial server 300 over the internal communication network, and are configured to transmit and receive certificate issue-related data. Accordingly, the financial server 300 may receive information on an issue history and current inventory condition of major certificates from the certificate issuing machine 100 in real time, and may perform comprehensive management on the major certificates based on the received information.

FIG. 2 is a block diagram for describing a schematic construction of the integrated certificate issuing machine for a financial institution according to an embodiment of the present disclosure. As illustrated in FIG. 2, the certificate issue module 110 of the integrated certificate issuing machine 100 for a financial institution according to an embodiment of the present disclosure is configured to include a bank account issue module 111 for issuing a bank account, a check issue module 112 for issuing a check, a card issue module 113 for issuing a card, and other certificate issue modules 114 for issuing various other certificates, such as transaction statement confirmation that is printed on paper and output.

Furthermore, the certificate issuing machine 100 is equipped with a certificate outlet (not illustrated) for discharging major certificates that are issued through the issue modules 111, 112, 113, and 114.

The certificate management unit 120 of the certificate issuing machine 100 is configured to include memory 121 in which various types of information including an issue history for each certificate and the quantity of major certificates remained are stored and kept, a communication unit 122 configured to transmit and receive certificate issue-related data to and from the staff terminal 200 and the financial server 300 over the internal communication network, and a control unit 123 configured to generate an issue number for a certificate assigned to a certificate issue request in response to the certificate issue request from the staff terminal 200 and to control the transmission and reception of data through the communication unit 122 and an operation of the certificate issue module 110.

The memory 121 stores and keeps information on certificates that are issued through the certificate issuing machine 100, such as certificate issue history for each major certificate and the quantity of major certificates remained. The memory 212 may also store instructions to be executed by the control unit 123.

The communication unit 122 is a component for transmitting and receiving certificate issue-related data to and from the staff terminal 200 and the financial server 300 over the internal communication network. The communication unit 122 may receive certificate issue request information from the staff terminal 200 and certificate-containing information (e.g., customer information and account information) to be printed on a certificate, and may transmit, to the staff terminal 200, reply information for a certificate issue request and an issue number for the certificate that has been generated by the control unit 123.

The control unit 123 is configured to generate an issue number for a certificate assigned to a certificate issue request from a customer in response to the certificate issue request through the staff terminal 200, to control an operation of the certificate issue module 110 so that the certificate issue module 110 issues the certificate that contains certificate-containing information based on the certificate-containing information that is received from the staff terminal 200 through the communication unit 122, and to store the generated issue number and the certificate-containing information received from the staff terminal 200 in the memory 121 by matching the generated issue number and the certificate-containing information after the issuing of the certificate. The control unit 123 may be embodied as one or more processors that read and execute the instructions stored in the memory 121 to perform these functions.

To this end, the certificate issue module 110 may be equipped with not-issued certificate loading storage having a cartridge form in which not-issued certificates are kept and printing means for printing certificate-containing information that is received from the staff terminal 200 through the communication unit 122.

In this case, a certificate that is issued through the issue modules 111, 112, 113, and 114 may be discharged through the certificate outlet and provided to a customer through the staff of the staff terminal.

In this case, the certificate outlet may be separately provided for each type of certificate. The certificate outlet is equipped with a shutter, and may be configured so that the shutter is opened and closed through the input of an ID tag or staff ID by a staff who has requested the issuing of a certificate.

That is, through such a construction, the integrated certificate issuing machine for a financial institution according to an embodiment of the present disclosure is connected to the multiple staff terminals for the processing of financial services in a financial institution over the internal communication network, and is configured to assign an issue number to a certificate assigned to a certificate issue request in response to the certificate issue request that is received through the staff terminal and to issue a major certificate that contains certificate-containing information through the staff of the staff terminal based on the certificate-containing information received from the staff terminal. Accordingly, it is possible to improve business efficiency of a staff because the issue and management of various types of major certificates, such as a bank account, a card, and a check that are used in a financial institution, can be integrated and effectively processed through one integrated certificate issuing machine. Furthermore, it is possible to prevent a loss/theft of a major certificate because an issue history of a major certificate and the quantity of major certificates remained can be checked in real time.

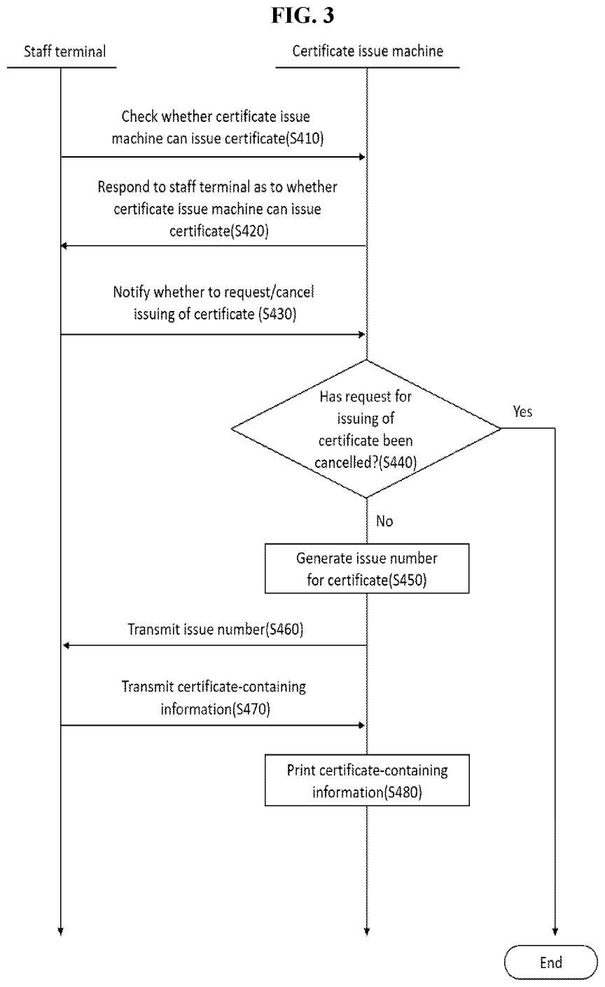

FIG. 3 is a flowchart for describing a process of issuing a major certificate through the integrated certificate issuing machine for a financial institution according to an embodiment of the present disclosure.

As illustrated in FIG. 3, a financial institution, such as a bank, provides financial business according to a certificate issue request from a customer. To this end, first, in response to the certificate issue request from the customer, when the staff terminal checks whether the certificate issuing machine can issue a certificate (S410), the certificate issuing machine responds to the staff terminal as to whether the certificate issuing machine can issue the certificate (S420).

In this case, in an embodiment of the present disclosure, the certificate issuing machine is connected to the multiple staff terminals for the processing of financial services, and receives a certificate issue request from each staff terminal. In this case, a queue according to certificate issue requests may be accumulated in the certificate issuing machine.

Accordingly, the certificate issuing machine sets priority for a certificate issue request for each major certificate according to the sequence in which the certificate issue request is received, and provides the staff terminal with waiting information, such as a waiting number and an expected waiting time, based on the set priority.

Thereafter, the staff terminal determines whether to request or cancel the issuing of the certificate based on the waiting information received from the certificate issuing machine, and finally notifies the determination to the certificate issuing machine (S430).

When the staff terminal requests the issuing of the certificate (“No” in S440), the certificate issuing machine includes the certificate issue request in the queue, and sequentially performs the issuing of requested certificates according to the priorities of the queue. However, when the staff terminal cancels the certificate issue request (“Yes” in S440) due to the delay of a waiting time or another reason, the certificate issuing machine deletes the certificate issue request from the queue and cancels the issuing of the certificate.

When the certificate issue request through the staff terminal is confirmed through such a process, the certificate issuing machine generates an issue number for the certificate assigned to the certificate issue request (S450) and transmits the generated issue number to the staff terminal (S460). The cancelation of the issuing of the major certificate having the issue number transmitted to the staff terminal is subsequently limited.

Thereafter, when receiving the issue number for the certificate from the certificate issuing machine, the staff terminal transmits, to the certificate issuing machine, certificate-containing information to be printed on the certificate (S470). In this case, the staff terminal stores and manages the certificate-containing information and the issue number for the certificate received from the certificate issuing machine in his or her terminal by matching the certificate-containing information and the issue number. Furthermore, the staff terminal may transmit corresponding information to the financial server.

Next, the certificate issuing machine issues a certificate on which the certificate-containing information has been printed (S490) by printing the certificate-containing information received from the staff terminal on a not-issued certificate that has been loaded therein (S480). Likewise, the certificate issuing machine may be configured to store certificate-containing information for certificates that have been issued and issue numbers for the certificates by matching the certificate-containing information and the issue numbers.

Thereafter, the staff of the staff terminal processes financial business for the issuing of the certificate by receiving the certificate issued through the certificate outlet provided in the certificate issuing machine and issuing the issued certificate to the customer.

That is, in an embodiment of the present disclosure, the issue and management of various types of major certificates, such as a bank account, a check, a card, and other certificates, can be comprehensively performed through one integrated certificate issuing machine that is disposed in a financial institution, such as a bank, and that is connected to multiple staff terminals. Accordingly, it is possible to improve business convenience of a staff because an issue history and inventory management of a major certificate are easy compared to a conventional technology. Furthermore, it is possible to prevent a loss/theft of a certificate because an issue history of a major certificate and the quantity of major certificates remained can be checked in real time.

As described above, the integrated certificate issuing machine for a financial institution and the operating method thereof according to embodiments of the present disclosure support that the issue and management of various types of major certificates, such as a bank account, a card, and a check that are used in a financial institution, such as a bank, can be effectively processed by integrating the issue and management through one integrated certificate issuing machine in a way that the integrated certificate issuing machine is connected to multiple staff terminals for the processing of financial services in the financial institution over an internal communication network and configured to assign an issue number to a certificate assigned to a certificate issue request in response to the certificate issue request that is received through the staff terminal, issue a major certificate that contains certificate-containing information based on the certificate-containing information received from the staff terminal, and issue the major certificate through the staff of the staff terminal in issuing and managing the major certificates, such as a bank account, a card, and a check, in the financial institution, such as a bank.

Furthermore, it may be evident to a person having ordinary knowledge in the art to which the present disclosure pertains that the present disclosure described above is not limited by the aforementioned embodiments and the accompanying drawings and may be substituted, modified, and changed in various ways without departing from the technical spirit of the present disclosure.

### DESCRIPTION OF REFERENCE NUMERALS

| | |
|---|---|
| 100: certificate issuing machine | 110: certificate issue module |
| 111: bank account issue module | 112: check issue module |
| 113: card issue module | 114: other certificate issue module |
| 120: certificate management unit | 121: memory |
| 122: communication unit | 123: control unit |
| 200: staff terminal | 300: financial server |

What is claimed is:

1. An integrated certificate issuing machine for a financial institution,
one or more processors; and
memory storing instructions thereon, the instructions when executed by the one or more processors cause the one or more processors to:
communicate with a plurality of staff terminals and a financial server over an internal communication network of a financial institution to issue and provide a requested certificate in response to receiving a certificate issue request from each of the plurality of staff terminals;
generate an issue number for the requested certificate assigned to each certificate issue request in response to receiving the certificate issue request from each of the plurality of staff terminals;
receive certificate-containing information to be contained in the requested certificate from each of the plurality of the staff terminals; and
issue a certificate printed with the received certificate-containing information,
wherein major financial certificates that are requested through the plurality of staff terminals are integrated, issued, and managed through the integrated certificate issuing machine.

2. The integrated certificate issuing machine of claim 1, wherein the major financial certificates comprise a bank account, a card, and a check.

3. The integrated certificate issuing machine of claim 1, comprising:
a certificate issue module configured to issue the certificate by printing the certificate-containing information received from the staff terminal on a not-issued certificate; and
a certificate management unit configured to control an operation of the certificate issue module and manage an issuing and issue history of the major financial certificates.

4. The integrated certificate issuing machine of claim 3, wherein the certificate issue module comprises:
a bank account issue module for issuing a bank account;
a check issue module for issuing a check;
a card issue module for issuing a card; and
other certificate issue module for issuing various other certificates that are printed on paper and output.

5. The integrated certificate issuing machine of claim 3, wherein the certificate issuing machine comprises a certificate outlet configured to discharge the major certificates issued by the certificate issue module.

6. The integrated certificate issuing machine of claim 3, wherein the certificate issue module comprises not-issued certificate loading storage configured to store not-issued certificates.

7. The integrated certificate issuing machine of claim 3, wherein the memory further stores certificate issue-related data comprising an issue history for each major certificate and a quantity of major certificates remained, and the instructions cause the one or more processors to generate the issue number for the requested certificate assigned to the certificate issue request in response to receiving the certificate issue request from each of the plurality of staff terminals and to control a transmission and reception of data through a communication unit and an operation of the certificate issue module, the communication unit configured to transmit and receive the certificate issue-related data to and from each of the plurality of staff terminals and the financial server over the internal communication network.

8. An operating method of integrating, issuing, and managing major financial certificates requested through a plurality of staff terminals by a certificate issuing machine, comprising:
checking, by a staff terminal, whether the certificate issuing machine connected to the staff terminals and a financial server over an internal communication network of a financial institution is able to issue a certificate;
responding, by the certificate issuing machine, to each of the staff terminals as to whether the certificate issuing machine is able to issue the certificate;
confirming, by the staff terminal, a certificate issue request and transmitting the certificate issue request to the certificate issuing machine;
generating, by the certificate issuing machine, an issue number for the certificate the issuing of which has been requested and transmitting the generated issue number to the staff terminal;
transmitting, by the staff terminal, certificate-containing information to be printed on the certificate having the generated issue number to the certificate issuing machine; and
issuing, by the certificate issuing machine, the certificate on which the certificate-containing information has been printed by printing the certificate-containing information received from the staff terminal on a not-issued certificate.

9. The operating method of claim 8, wherein the responding to the staff terminal comprises:
setting priority for a certificate issue request for each major financial certificate according to a sequence in which certificate issue requests are received, and
providing, to each of the staff terminals, waiting information according to the set priority.

10. The operating method of claim 8, wherein the certificate issuing machine stores issue history information in which the issue number of the issued major financial certificate and the certificate-containing information are matched and contained.
